(19) United States
(12) Patent Application Publication
(10) Pub. No.: US 2022/0134304 A1
(43) Pub. Date: May 5, 2022

(54) METHOD FOR MANUFACTURING AN APPARATUS FOR EXCHANGING HEAT AND MATERIAL

(71) Applicant: L'Air Liquide, Société Anonyme pour l'Etude et I'Exploitation des Procédés Georges Claude, Paris (FR)

(72) Inventors: Eric MASLIAH, Brunoy (FR); Camille MARIE, Paris (FR); Ludovic AMANT, Vaires sur Marne (FR); Patrick LE BOT, Vincennes (FR)

(21) Appl. No.: 17/433,254

(22) PCT Filed: Feb. 25, 2020
(86) PCT No.: PCT/FR2020/050354

§ 371 Date: Aug. 24, 2021

(30) Foreign Application Priority Data
Feb. 25, 2019 (FR) 1901868
Feb. 25, 2019 (FR) 1901869
Feb. 25, 2019 (FR) 1901872

(51) Int. Cl. B01J 19/32; B01D 53/18; B23P 15/26; F28D 9/00

(52) U.S. Cl. CPC B01J 19/32; B01D 53/18; B01J 2219/32272; F28D 9/0031; B01J 2219/32213; B23P 15/26

(57) ABSTRACT

A method for manufacturing a heat and material exchange apparatus having a plurality of columns and by a series of at least three metal plates of rectangular section, the plates being substantially all of the same shape and dimensions, each plate being separated from the adjacent plate by a group of hollow metal columns that are aligned and have a section which is polygonal, the columns of each group being parallel to one another, at least some of the columns of a group containing a material and heat exchange means, at least the parts of the plates which are in contact with the columns being coated with a brazing material wherein the plates are secured to the columns by placing the exchange apparatus in a furnace and by heating the furnace in order to braze the apparatus to form a parallelepipedal block.

### CROSS REFERENCE TO RELATED APPLICATIONS

This application is a 371 of International Application No. PCT/FR2020/050354, filed Feb. 25, 2020, which claims priority to French Patent Application Nos. 1901868, 1901869, and 1901872, all filed Feb. 25, 2019, the entire contents of which are incorporated herein by reference.

### BACKGROUND

The present invention relates to a method for manufacturing a material and heat exchange apparatus. It also relates to an exchange apparatus manufactured by the process.

Material and/or heat exchange columns are today used in a wide variety of processes. For example, these material and/or heat exchange columns allow scrubbing processes, cooling processes, heating processes or distillation processes to be implemented.

All of these processes are based on a single basic principle, namely material and/or heat exchange between two fluids. These two fluids may be, for example, two liquids, two gases or else one liquid and one gas.

Such columns thus comprise at least one material and/or heat exchange means which the two fluids pass through and in which the material and/or heat exchange between these two fluids take place.

Usually, a material and/or heat exchange column is manufactured by disposing corrugated lamellae, which are grouped together in blocks so as to form structured packings, inside a cylindrical shell. The method is slow and expensive, due to the dimensions of the columns and also due to the complexity of the manufacture and installation of the packings.

It is also known for a heat exchanger body to be produced by forming a stack of rectangular plates, which are separated by perforated fins, and subsequently brazing the stack so as to form a body having a plurality of passages. This type of body is subsequently used to transfer heat from one fluid to the other, the fluid in a passage with fins transferring its heat through the plate to the fluid in the adjacent passage with fins.

Although this type of body is used everywhere as a heat exchanger, it has never been used on an industrial scale for the separation of fluids at temperatures below 0° C.

### SUMMARY

The present invention aims to propose a fast and efficient way of manufacturing a material and/or heat exchange apparatus. It also makes it possible to produce an apparatus for separation which is easy to manufacture with improved performance compared to a simple plate and fin heat exchanger used as a dephlegmator.

Using a multiplicity of columns containing means allowing material and heat exchange allows the flow of the fluids through the spaces between the plates to be made uniform. The columns minimize the edge effects encountered when the fluids pass through a larger space. The columns, all or substantially all supplied by a flow of the same fluid, allow a separation or a mixing of fluids to be carried out, for example a scrubbing or a distillation.

According to one aspect of the invention, a method for manufacturing a heat and material exchange apparatus is provided that is constituted by a plurality of columns and by a series of at least three metal plates of rectangular section, the plates being substantially all of the same shape and dimensions, each plate being separated from the adjacent plate by a group of hollow metal columns that are aligned and have a section which is polygonal, which is preferably rectangular, the columns of each group being parallel to one another, optionally all the columns of the apparatus being parallel to one another, the columns of each group each being in contact with the two metal plates on either side of the group, at least some of the columns of a group, or even of each group, or even all the columns of a group, containing a material and heat exchange means, for example a packing such as a random metal packing, at least the parts of the plates which are in contact with the columns being coated with a brazing material wherein the plates are secured to the columns by placing the exchange apparatus in a furnace and by heating the furnace in order to braze the apparatus to form a parallelepipedal block.

According to other optional aspects:
the maximum temperature experienced by the apparatus during brazing is lower than the melting point of the plates, than the melting point of the columns and preferably than the melting point of the material and heat exchange means.
the plates, the columns and optionally the material and heat exchange means are all formed i) of the same metal or ii) of the same alloy or iii) of alloys with the same main metal.
the plates and/or the columns and/or the material and heat exchange means is/are made of one of the following metals: aluminum, stainless steel, nickel, copper or titanium.
the material and heat exchange means is made of stainless steel.
at least some of the columns have a rectangular or square section.
the minimum dimension of an edge of the section of a column is greater than 2 cm and preferably greater than 10 cm.
the minimum dimension of an edge of the section of a column is less than 10 cm.
the length of a plate is at least equal to 1 m.
the columns are filled with packing, preferably random packing, the plates and the groups of columns filled, preferably entirely, with packing are stacked so as to form the apparatus and the apparatus is subsequently brazed in order to secure the columns to the plates.
the plates are solid.
the plates are not perforated.
at least one of the plates is solid but comprises a number of localized perforations, for example for allowing fluid to pass from one passage to the adjacent one, or for balancing the distribution of the liquid or the pressure drops on the gas side.
each of the columns is a separate element.

According to another aspect of the invention, a heat and/or material exchange apparatus is provided that is constituted by a series of metal plates of rectangular section, each plate being separated from the adjacent plate by a group of hollow metal columns that are aligned and have a section which is preferably rectangular, the columns of each group being parallel to one another, the columns of each group each being in contact with the two metal plates on either side of the group, at least some of the columns of a group, or even of each group, or even all the columns of a group, containing a material and heat exchange means, for example a packing, such as a random metal packing, at least the parts which are in contact with the columns being coated prior to brazing with a brazing material, the exchange apparatus being manufactured by a method as described above.

According to other optional aspects:
each plate is separated from the adjacent plate by several series of hollow metal columns that are aligned and have a section which is preferably rectangular, the columns of each series being parallel to one another, the columns of each group each being in contact with the two metal plates on either side of the series.

The invention also comprises an apparatus for separation, for example by distillation or by scrubbing, for use at temperatures below 0° C., comprising a heat and material exchange apparatus as described above, the apparatus being oriented such that, in use, a liquid introduced into a column flows in each column under gravity, means for sending a fluid to be separated to the exchange apparatus comprising at least two components, means for extracting, from at least one end of the apparatus, at least one separated fluid enriched in one of the components of the fluid to be separated, and means for insulating the exchange apparatus, for example an insulated chamber containing the exchange apparatus.

Preferably, the means for sending the fluid to be separated to the exchange apparatus are connected to at least two thirds of the columns, or even to each column in order to send some of the fluid to be separated to at least two thirds of the columns, or even to each column.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a schematic perspective view of a material and/or heat exchange apparatus manufactured according to the present invention.

FIG. 2 is a partial view, in horizontal cross section, of the material and/or heat exchange apparatus according to the invention.

FIG. 3 is a partial view, in horizontal cross section, of two material and/or heat exchange columns of an apparatus according to the invention.

FIG. 4 illustrates a cross section of the interior of a material and heat exchange apparatus according to the invention.

FIG. 5 illustrates an alternative arrangement of the columns of a zone of the apparatus according to the invention.

### NOTATION AND NOMENCLATURE

In the remainder of the description, the terms “direct and/or indirect heat exchange and material transfer means” and “exchange means” will be used without distinction. Similarly, the terms “direct and/or indirect heat exchange and material transfer exchange apparatus” and “apparatus” will be used without distinction. A vertical direction corresponds to a main direction of extension of an apparatus according to the invention, when this apparatus is in a functional position, i.e. a position in which a direct and/or indirect heat and material exchange can take place.

### DETAILED DESCRIPTION OF PREFERRED EMBODIMENTS

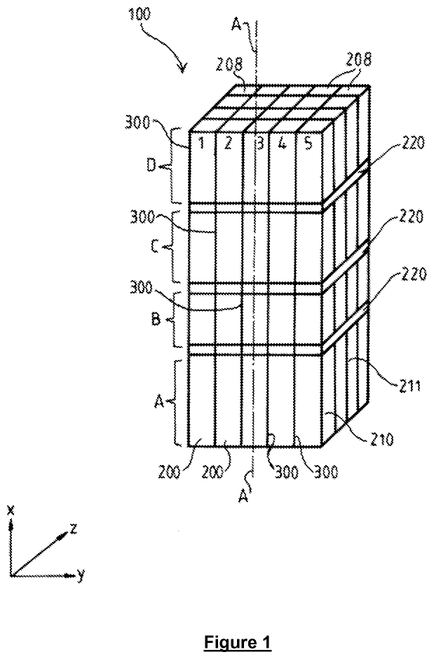

FIG. 1 thus illustrates a direct and indirect heat exchange and material transfer apparatus 100 according to the invention, in a method of assembly by brazing, which comprises three direct exchange and material transfer zones A, C and D and incorporates an indirect heat exchange zone B for indirect heat exchange of the vaporizer-condenser type. This apparatus comprises a plurality of at least two, or even at least three, preferably at least ten, flat plates 300 of rectangular section, and a plurality of direct heat exchange and material transfer columns 200. The flat plates 300 are the same shape and have the same dimensions. The plates can be solid, i.e. not perforated.

Now, a plate can be considered solid even if it comprises a number of localized perforations for allowing fluid to pass from one passage to the adjacent one, or for balancing the distribution of the liquid or the pressure drops on the gas side. The apparatus is in the form of a parallelepipedal block with a rectangular, or even square, section. The length of the apparatus is that of the plates along the axis X. Its width is that of the plates along the axis Z and its thickness depends on the number of plates and the dimensions along the axis Y of the material and/or heat exchange columns.

These plates 300 are disposed with their length vertical along the axis X and their width horizontal along the axis Z in use as a material and heat exchange means.

According to the example illustrated here, the apparatus comprises five flat plates 300 and eighty columns 200. A sixth flat plate 300 forming part of the stack normally has to cover the surface defined by the length of the apparatus and its width. This plate is not illustrated, for better perception of the construction of the apparatus.

The length of the plates 300 is at least equal to 1 m, preferably at least equal to 2 m, or even at least equal to 3 m.

The columns are disposed in three zones A, C, D, each zone comprising twenty columns disposed in five rows 1, 2, 3, 4, 5, each row comprising four columns. The columns 200 are all of identical construction, even though their dimensions can differ. In this case, each of the sixty columns has the same square section. The columns can all have the same rectangular section or simply the same section.

These columns are preferably columns that are readily commercially available and can be ordered in large quantities, at low cost and with dimensions and geometries corresponding to their role in the apparatus. This makes it possible both to standardize apparatuses so as to simplify their manufacture and reduce the costs thereof, and also to dimension other apparatuses with greater precision if the needs of the customer are more specific. In the direction Y, these columns typically have a dimension of a few centimeters, i.e. between 2 cm and 10 cm. In the direction Z, this dimension is also typically a few centimeters, or even a few decimeters.

Before brazing, the columns 200 are separate elements, each one separable from each of the others. After brazing, they may or may not be secured to one another.

The columns of a single zone A, C, D have the same length so as to form a parallelepipedal block of twenty columns 200.

In section B, in order to ensure indirect heat exchange of the vaporizer-condenser type, it is possible to divide the stack using spacer sheets 301 and to use conventional exchange corrugations as described by ALPEMA. The advantage of disposing the vaporizer-condenser in the apparatus, in addition to combining the functions, is to ensure a certain even distribution of the flows in the various passages (separated by the sheets 300), either by ensuring liquid reflux for zone A and by driving the flow of the gas in this passage by virtue of the condensation, or by ensuring the reboiling of zones C and D by partially vaporizing the liquid coming from zone C so as to ensure a rising gas flow in zones C and D.

The number of passages in section B is preferably at least two passages so as to have, above each passage of zone A that is determined by the sheets 300, a passage in zone B performing condensation so as to supply zone A with liquid, and, below each passage of zone C, a passage in zone B performing vaporization so as to supply zone C with gas.

It will be understood that the zones can have different lengths depending on the functionality that they have to have, and the length of the columns is chosen depending on that of the zones.

The walls of the columns are preferably solid such that a fluid cannot pass through them.

The number of columns in each section may differ from one section to another. The columns are not necessarily of square section but can have a section that is rectangular, or even polygonal, for example triangular or of a polygonal shape with two parallel sides, for example octagonal.

Each column 200 is sandwiched between two flat plates 300, in contact with these two plates, hence the advantage of having a section with two parallel walls. It will be understood that flat plates 500 can be disposed on the faces of the columns on the right and on the left in FIG. 1 (in the plane (X, Z)) so as to close the apparatus, these plates not being illustrated so as to allow the interior structure of the apparatus to be seen. Alternatively, it is possible to increase the thickness of the flat plates 300 situated on the outside of the apparatus so as to make the apparatus more robust.

Each space between a pair of adjacent plates 300 contains an alignment 208 of four columns 200 that touch along the axis Z.

There will also optionally be bars 400 for closing the spaces between the plates 300 on the front and at the rear of the apparatus 100, but these would prevent the columns 200 from being seen and are therefore not illustrated here.

Nevertheless, it is conceivable that the bars 400 are not present, and that the sealing is ensured by the columns themselves or by another means, such as glue.

In this figure, as each column has the same section and each zone comprises the same number of columns, it is easy to arrange each column 200 of a row directly below the column of the zone above.

Each column is in contact with one other column, if it is located at the end of a row, or with two other columns.

The description that will be given below of one of them applies, mutatis mutandis, to all of the constituent columns 200 of the apparatus 100 illustrated in FIG. 1.

According to the example illustrated here, the apparatus 100 is shown in its operating position.

“Operating position” is understood to mean a position in which the apparatus 100 can be used. Each column 200 has a main axis of extension parallel to the main direction of extension X of the material and/or heat exchange apparatus 100. When the apparatus 100 is in a vertical position, i.e. its operating position, this main axis X of extension is a vertical axis. It is understood that this is only one exemplary embodiment of the present invention and that the apparatus 100 and the constituent columns 200 of this apparatus 100 could have a different shape without departing from the context of the present invention. The axis Y represents the stacking of the apparatus, which depends on the number of plates 300 stacked and the dimensions of the columns 200. The axis Z represents the width of the apparatus, which corresponds to the width of the plates 300.

The apparatus optionally comprises a closure means constituted by lateral bars 400 that are connected to the edge of the plates in a sealed manner.

Such an apparatus 100 is configured to allow at least one material transfer and one indirect heat exchange between two fluids. For example, the apparatus can thus be configured to allow an exchange of material and heat between a liquid that circulates in the apparatus in a first direction and a gas that circulates in the apparatus in a second direction. It is understood that any other process for exchanging material and heat between two fluids can be implemented by the apparatus 100 according to the invention without departing from the context thereof. For example, the apparatus 100 can be configured to implement a scrubbing process and/or a distillation process.

The apparatus can allow contact, for the heat and material exchange, between a gas phase rising along the axis of the apparatus and a liquid phase descending under gravity.

The apparatus can also contain the operating pressure by virtue of the brazed mechanical connections between plates and lateral bars.

In any case, the apparatus 100 according to the invention comprises at least one intake for the first fluid, for example a liquid intake, and at least one intake for the second fluid, for example a gas intake, these fluid intakes not being shown in the figures described here.

Each column 200 comprises four walls 202 surrounding a space 204 that is open at both ends so as to allow fluid to pass through the column in the lengthwise direction. No fluid can pass through the four walls.

The column contains a means for transferring mass and heat. This means can be a structured or random packing.

Packing is understood to mean any type of structure that makes it possible to obtain a significant contact surface for contact between a liquid phase and a gas phase and thus to improve the exchanges between the liquid phase and the gas phase.

The contact surface of this packing is larger than the contact surface constituted by the internal walls of the columns 200, preferably much larger.

Disordered irregular stacks of individual elements having specific shapes, for example rings, spirals, etc., are called random packings. Exchanges of heat and/or of material are carried out with the aid of these individual elements. These individual elements can be made of metal, ceramic, plastic or similar materials. “Packed Bed Columns” by N. Kolev, Elsevier, 2006, pp 154-161, describes exemplary individual elements for random packing.

Random packing offers advantageous qualities in terms of transfer efficiency, low pressure drop and simplicity of installation. It comprises, for example, Raschig rings, Pall rings, beads, spiral prismatic packings. Other types of packing are of course conceivable, such as structured packings, which are more complex to implement, or metal foam.

The use of random packings is particularly recommended since it makes it possible to have within reach a source of readily commercially available packing that can be chosen so as to have very specific characteristics or can be bought in large quantities at low cost for standardized apparatuses. These packings are readily commercially available and can be ordered in large quantities, at low cost and with dimensions and geometries corresponding to their role in the apparatus. This makes it possible both to standardize apparatuses so as to simplify their manufacture and reduce the costs thereof, and also to dimension other apparatuses with greater precision if the needs of the customer are more specific.

Preferably, the column is entirely filled by the packing.

The plates, the columns and the mass and heat transfer means are preferably made of metal, for example aluminum, stainless steel, nickel, copper or titanium. The plates, the columns and optionally the material and heat exchange means are preferably formed i) of the same metal or ii) of the same alloy or iii) of alloys with the same main metal.

The packing can be made of stainless steel or a material that is more compatible with oxygen such as copper, nickel, Inconel®, Monel®, etc.

The plate of each pair of adjacent plates is contiguous with the columns between the pair of plates and the columns in the space between the pair of plates are contiguous with one another.

Preferably, the columns are not coated with brazing material, but they can be. It is the sheets known as separator sheets 300 that are generally coated with braze on both sides.

Preferably, the space between two adjacent plates has a width that is substantially equal to one of the small dimensions of the exchange column, such that each column touches two adjacent plates, even before the brazing operation.

Each column of a zone C can be separated from the column of the adjacent zone D by distribution or separation means 220, in contact with the adjacent plates 300.

Preferably, as illustrated, the distribution means are common to the four columns of an alignment 208 between two plates 300. By contrast, the distribution means are disposed in the spaces between two plates 300 and do not cross the plates.

Once the plates, the columns pre-filled with packing and the distribution means have been put in place, the apparatus is placed in a furnace in an inert or reducing atmosphere and is brazed in order to secure the columns and the distribution means to the plates.

The temperature of the furnace is chosen such that the columns are each secured to two plates on opposite sides, and this is sufficient for the apparatus to subsequently form a block. By contrast, the packings are not negatively affected by the brazing operation, such that a fluid introduced into the columns can be separated by a series of steps of condensation and vaporization on the packings of the columns. Likewise, the columns are not brazed to one another.

The maximum temperature experienced by the apparatus during brazing is lower than the melting point of the plates, a plate being considered to be separate from its braze coating, lower than the melting point of the columns and preferably lower than the melting point of the material and heat exchange means.

Brazing creates a metallic bond between the plates and the columns and distribution means in contact with the plates. The use of columns with a polygonal section can make it possible to have a large contact surface in common with the plates and thus better cohesion of the apparatus.

The columns do not need to be attached to one another before the brazing step, and this considerably simplifies the manufacture of the apparatus.

These are preferably isolated columns, each one independent of the others. Their dimensions and the means for introducing fluids into the columns are chosen so as to limit the inflows of gas or liquid toward the plates.

The distribution means are also secured to the plates by the brazing operation and are not fastened to the columns or to the plates before the brazing operation.

It is preferable for the fluid that is to be separated or mixed to be introduced into each of the columns, and the apparatus comprises means for introducing a fraction of the fluid into each of the columns of one of the zones A, C or D, preferably into the lower part of zone D.

The fluid that is to be separated or mixed is sent only into the columns and is not directly in contact with the plates.

Next, the fluid to be separated becomes enriched in its lightest component, rising through the packings of each column and passing from one zone of columns to the one above.

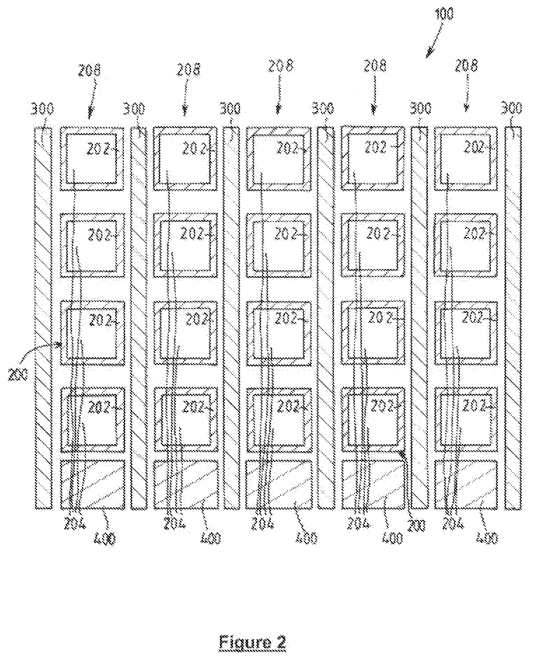

As will be described in greater detail below, each column 200 comprises at least one peripheral wall 202 that delimits an internal volume of the column 200 in question. More specifically, each peripheral wall 202 comprises at least one external face 211 via which it is juxtaposed with another column 200, i.e. with the external face of the peripheral wall of this other column, and an internal face 212, which is for example visible in FIG. 2, which delimits this internal volume. At least one material and heat exchange means 230—also shown in FIG. 2—is arranged in this internal volume.

Advantageously, at least one material and heat exchange means is arranged in each column 200, each of these exchange means being received in a compartment 204 of the column 200 in question, each compartment 204 being at least partially delimited at the top by at least one distribution device 220. These distribution devices 220 are configured to ensure an even distribution of at least the first fluid, advantageously of the first fluid and the second fluid, over the one or more material and/or heat exchange means. It is understood that this homogenization makes it possible to promote material and heat exchanges that take place in these exchange means.

According to the example illustrated in FIG. 1, the apparatus 100 comprises three distribution devices 220, thus dividing the apparatus into four zones. It is understood that this is only one particular exemplary embodiment of the present invention and that this example in no way limits the present invention.

These four zones can operate at different pressures and/or have different functions. For example, zone A can operate at 6 bar and zones C and D at a pressure of 1.4 bar.

Advantageously, the elements disposed in the apparatus 100 are brazed together during the brazing operation that allows the columns 200 to be secured to one another. In other words, the material and/or heat exchange apparatus 100 is completely assembled in a single step.

After brazing, if the apparatus has to operate at a temperature that is very low or very high relative to ambient temperature, it can be coated with insulation. Otherwise, the apparatus can be disposed inside an insulated chamber.

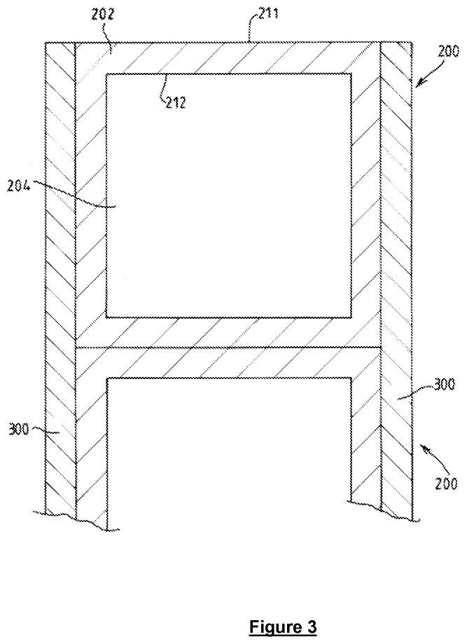

With reference to FIGS. 2 and 3, an exemplary exchange column of an apparatus according to the invention, containing a material and/or heat exchange means and its arrangement in the apparatus will now be described in greater detail. These FIGS. 2 and 3 partially illustrate a horizontal cross section, i.e. a cross section taken on a plane in which the main axis X of extension of the columns 200 is inscribed, of FIG. 1.

FIG. 2 illustrates an exemplary embodiment of the present invention in which showing the twenty columns of a zone of the apparatus. The dimensions of the spaces between columns 200 and between a column and a plate are exaggerated for better appreciation that each column 200 is individual and is not attached either to the adjacent plate or to the neighboring columns before brazing. The dimension of the plates 300 is also exaggerated since, in general, it will be about 1 mm whereas the square columns 202 will have centimeter-scale dimensions and thicknesses of a few millimeters depending on the requirements in terms of mechanical compression strength at high temperature during the phase of brazing in a furnace and in terms of mechanical ability to withstand pressure during use of the apparatus.

In this example, the apparatus is divided into a series of zones, but the apparatus can, in absolute terms, comprise only a single zone, in which case the length of the columns is practically that of the plates.

In the most probable case, in which the apparatus comprises a plurality of zones, the columns will have a length at most equal to that of the extent of the zone in the direction of the length of the plate.

It can be seen that, between each pair of plates 300, there is an alignment of four columns 200 of square section with four walls 202 having a length that can be equal to the length of the plate or equal to a fraction of the length of the plate.

FIG. 3 shows a part of the zone in FIG. 2 after the brazing process. It can be seen that the column 200 is sandwiched between two plates 300 coated with brazing materials. Two opposite walls of the walls 202 of the column 200 are each connected to an opposite plate 300. The two other opposite walls 202 are contiguous with the walls of the adjacent columns or of the adjacent column and of the closure bar. The interior 204 of the column contains at least one means of promoting material and heat exchange, such as a random packing.

FIGS. 1, 2 and 3 essentially describe a method of assembling the apparatus by brazing. It is also possible to produce such an apparatus using another assembly method or a combination of assembly methods such as brazing, riveting, adhesive bonding or welding. By way of example, it is possible to produce section B alone by brazing and join it by welding to sections A, C and D that would also have been produced by welding.

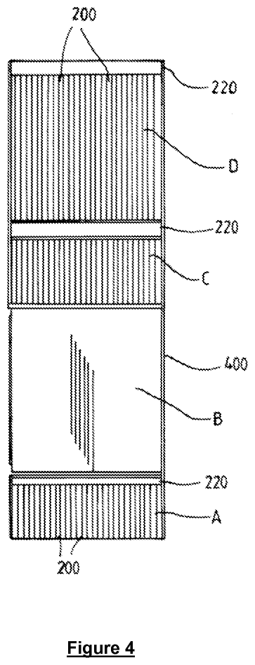

FIG. 4 illustrates a cross section of an apparatus according to the invention that is capable of being used for the distillation of air, for example. The cross section corresponds to that on line A-A in FIG. 1, even if the example in FIG. 4 uses rows of columns between two plates with far more columns than the four in FIG. 1. The direction of the stack of the plates 300 goes into the page (axis Y). Twenty-eight columns 200 are aligned in the space between the same two adjacent plates for each of the zones A, C, D, zone B not containing columns 200. The same is true for each pair of plates of the stack of plates. Zone A corresponding to the medium-pressure column is supplied via its bottom end such that the cooled gas mixture to be separated, in this case air, is sent to each of the columns 200 of zone A. The air rises in the columns, becoming enriched in nitrogen and depleted in oxygen as it passes through the random packings in the interior 204 of each column. It is possible that a small minority of the columns are not supplied with air, without departing from the invention. Next, the gas travels via the distribution means 220 so as to pass into zone B. Zone B is supplied with liquid oxygen descending from zone C through a distribution means. Zone B comprises the alternating passages for oxygen vaporization and nitrogen condensation, each passage being used either for vaporization or for condensation and the heat traveling through the plates 300 delimiting the passages.

The liquid nitrogen distributed by the distribution means 220 drops back into the columns of zone A so as to act as reflux.

The gaseous oxygen rises into zone C. Zone C is also supplied from above with an oxygen-enriched liquid coming from the lower part of zone A. Condensed nitrogen coming from the condenser B is also sent to the distribution means 220 above zone D.

The liquids sent to zones D and C are separated in these zones by distillation so as to produce a nitrogen-rich gas withdrawn from the columns 200 of zone D and an oxygen-rich liquid is taken from the columns 200 of zone C.

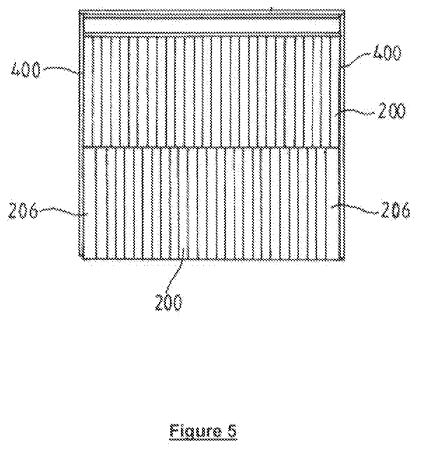

FIG. 5 shows that the columns 200 do not necessarily have the same length as the extent of the zone in the direction of the length of the plate 300. The illustrated zone can be one of zones A, C or D.

In this case, the columns 200 have a length equal to half the dimension of the zone in the vertical direction. The top columns 200 are offset with respect to those below by installing columns of rectangular section 206 on either side of the group of columns 200 of square section.

This allows greater liquid and gas agitation within a zone, since the liquids and gases do not remain in a single column while passing through the zone.

Brazing may or may not be performed under vacuum.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

1.-12. (canceled)

13. A method for manufacturing a heat and material exchange apparatus comprising a plurality of columns and by a series of at least three metal plates of rectangular section, the plates being substantially all of the same shape and dimensions, each plate being separated from the adjacent plate by a group of hollow metal columns that are aligned and have a section which is polygonal, the columns of each group being parallel to one another, the columns of each group each being in contact with the two metal plates on either side of the group, at least some of the columns of a group containing a material and heat exchange means, at least the parts of the plates which are in contact with the columns being coated with a brazing material wherein the plates are secured to the columns by placing the exchange apparatus in a furnace and by heating the furnace in order to braze the apparatus to form a parallelepipedal block.

14. The method as claimed in claim 13, wherein the maximum temperature experienced by the apparatus during brazing is lower than the melting point of the plates, than the melting point of the columns, and than the melting point of the material and heat exchange means.

15. The method as claimed in claim 13, wherein the plates, the columns, and the material and heat exchange means are all formed i) of the same metal or ii) of the same alloy or iii) of alloys with the same main metal.

16. The method as claimed in claim 13, wherein the plates and/or the columns and/or the material and heat exchange means is/are made of one of the following metals: aluminum, stainless steel, nickel, copper or titanium.

17. The method as claimed in claim 13, wherein at least some of the columns have a rectangular or square section.

18. The method as claimed in claim 13, wherein the minimum dimension of an edge of the section of a column is greater than 2.

19. The method as claimed in claim 13, wherein the length of a plate is at least equal to 1 m.

20. The method as claimed in claim 13, wherein the columns are filled with packing, the plates and the groups of columns filled with packing are stacked so as to form the apparatus and the apparatus is subsequently brazed in order to secure the columns to the plates.

21. A heat and/or material exchange apparatus comprising a series of metal plates of rectangular section, each plate being separated from the adjacent plate by a group of hollow metal columns that are aligned and have a section which is rectangular, the columns of each group being parallel to one another, the columns of each group each being in contact with the two metal plates on either side of the group, at least some of the columns of a group, or even of each group, or even all the columns of a group, containing a material and heat exchange means, at least the parts which are in contact with the columns being coated prior to brazing with a brazing material, the exchange apparatus being manufactured by a method as claimed in claim 13.

22. The apparatus as claimed in claim 21, wherein each plate is separated from the adjacent plate by several series of hollow metal columns that are aligned and have a section which is preferably rectangular, the columns of each series being parallel to one another, the columns of each group each being in contact with the two metal plates on either side of the series.

23. An apparatus for separation, for use at temperatures below 0° C., comprising a heat and material exchange apparatus as claimed in claim 21, the apparatus being oriented such that, in use, a liquid introduced into a column flows in each column under gravity, a means for sending a fluid to be separated to the exchange apparatus comprising at least two components, a means for extracting, from at least one end of the apparatus, at least one separated fluid enriched in one of the components of the fluid to be separated, and a means for insulating the exchange apparatus, for example an insulated chamber containing the exchange apparatus.

24. The apparatus as claimed in claim 21, wherein the means for sending the fluid to be separated to the exchange apparatus are connected to at least two thirds of the columns in order to send some of the fluid to be separated to at least two thirds of the columns.
